(19) United States
(12) Patent Application Publication
(10) Pub. No.: US 2005/0192824 A1
(43) Pub. Date: Sep. 1, 2005

(54) System and method for determining a behavior of a classifier for use with business data

(75) Inventors: Hinrich H. Schuetze, San Francisco, CA (US); Omor Emre Velipasaoglu, San Francisco, CA (US); Chia-Hao Yu, Davis, CA (US); Stan Stukov, Hillsborough, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ENKATA Technologies, San Mateo, CA (US)

(21) Appl. No.: 10/890,018

(22) Filed: Jul. 12, 2004

Related U.S. Application Data
(60) Provisional application No. 60/490,219, filed on Jul. 25, 2003.

(51) Int. Cl. G06F 17/60; G06F 15/18; G06F 17/30; G06F 7/00

(52) U.S. Cl. 705/1; 706/12; 706/20

(57) ABSTRACT

A method for detecting change in business data using a statistical classifier process. The method includes inputting a first set of business data in a first format from a real business process from a first data source and storing the first set of business data into one or more memories. The method also includes inputting a second set of business data in a second format from a real business process from a second data source and storing the second set of business data into one or more memories. The method forms a statistical classifier by inputting the first set of business data into a learning process associating with the statistical classifier that processes business the data in the first format. The method stores the classifier into the one or more memories, the classifier being associated with the first set of data in the first format and processes the data from the first data source in the statistical classifier to derive a first result. The method also processes the data from the second data source in the statistical classifier to derive a second result and determines a behavior of the statistical classifier based upon at least the first result and the second result. The method displays information associated with the behavior of the statistical classifier.

### CROSS REFERENCE TO RELATED APPLICATIONS

This application claims priority to U.S. Provisional Application No.60/490,219 entitled “SYSTEM AND METHOD FOR EFFICIENT ENRICHMENT OF BUSINESS DATA”, and filed on Jul. 25, 2003 (Attorney Docket No. 021269-000500US), and incorporated herein by reference.

### BACKGROUND OF THE INVENTION

The present invention relates generally to supporting business decisions through data analysis by way of enriching data through data mining, text mining, and automatic classification. More particularly, the invention provides a method and system for 1) automatic detection of change in the business processes to be analyzed; 2) accurate measurement of the performance of automatic classification of business process data; 3) automatic handling of semi-structured text in business process analysis; and 4) efficient and maintainable scripting of the data enrichment process. Business decisions generally require knowledge about properties of business entities related to the decision. Such properties can be inferred by an automatic classifier that processes data associated with the entity. Parts of the data may be human-generated or free form text. Other parts of the data may be machine-generated or semi-structured. It is beneficial to analyze both free form text and semi-structured text data for business process analysis. While the enrichment process can be programmed in a number of existing programming languages and data base query languages, it is advantageous to provide a specialized language for increased maintainability and faster development of the enrichment process. By way of example for the enabling features of such a language, we describe SQXML, a language developed by Enkata Technologies, Inc. for this purpose. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

Common goals of almost every business are to increase profits and improve operations. Profits are generally derived from revenues less costs. Operations include manufacturing, sales, service, and other features of the business. Companies spent considerable time and effort to control costs to improve profits and operations. Many such companies rely upon feedback from a customer or detailed analysis of company finances and/or operations. Most particularly, companies collect all types of information in the form of data. such information includes customer feedback, financial data, reliability information, product performance data, employee performance data, and customer data.

With the proliferation of computers and databases, companies have seen an explosion in the amount of information or data collected. Using telephone call centers as an example, there are literally over one hundred million customer calls received each day in the United States. Such calls are often categorized and then stored for analysis. Large quantities of data are often collected. Unfortunately, conventional techniques for analyzing such information are often time consuming and not efficient. That is, such techniques are often manual and require much effort.

Accordingly, companies are often unable to identify certain business improvement opportunities. Much of the raw data including voice and free-form text data are in unstructured form thereby rendering the data almost unusable to traditional analytical software tools. Moreover, companies must often manually build and apply relevancy scoring models to identify improvement opportunities and associate raw data with financial models of the business to quantify size of these opportunities. An identification of granular improvement opportunities would often require the identification of complex multi-dimensional patterns in the raw data that is difficult to do manually.

Examples of these techniques include statistical modeling, support vector machines, and others. These modeling techniques have had some success. Unfortunately, certain limitations still exist. That is, statistical classifiers must often be established to carry out these techniques. Such statistical classifiers often become inaccurate over time and must be reformed. Conventional techniques for reforming statistical classifiers are often cumbersome and difficult to perform. Although these techniques have had certain success, there are many limitations.

From the above, it is seen that techniques for processing information are highly desired.

### SUMMARY OF INVENTION

According to the present invention, techniques for supporting business decisions through data analysis by way of enriching data through data mining, text mining, and automatic classification are provided. More particularly, the invention provides a method and system for 1) automatic detection of change in the business processes to be analyzed; 2) accurate measurement of the performance of automatic classification of business process data; 3) automatic handling of semi-structured text in business process analysis; and 4) efficient and maintainable scripting of the data enrichment process. Business decisions generally require knowledge about properties of business entities related to the decision. Such properties can be inferred by an automatic classifier that processes data associated with the entity. Parts of the data may be human-generated or free form text. Other parts of the data may be machine-generated or semi-structured. It is beneficial to analyze both free form text and semi-structured text data for business process analysis. While the enrichment process can be programmed in a number of existing programming languages and data base query languages, it is advantageous to provide a specialized language for increased maintainability and faster development of the enrichment process. By way of example for the enabling features of such a language, we describe SQXML, a language developed by Enkata Technologies, Inc. for this purpose. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

In a specific embodiment, the present invention provides a method for detecting change in business data using a statistical classifier process. The method includes inputting a first set of business data in a first format from a real business process from a first data source and storing the first set of business data into one or more memories. The method also includes inputting a second set of business data in a second format from a real business process from a second data source and storing the second set of business data into one or more memories. The method forms a statistical classifier by inputting the first set of business data into a learning process associating with the statistical classifier that processes business the data in the first format. The method stores the classifier into the one or more memories, the classifier being associated with the first set of data in the first format and processes the data from the first data source in the statistical classifier to derive a first result. The method also processes the data from the second data source in the statistical classifier to derive a second result and determines a behavior of the statistical classifier based upon at least the first result and the second result. The method displays information associated with the behavior of the statistical classifier.

In an alternative specific embodiment, the present invention provides a method for detecting change in business data using a statistical classifier process. The method inputs a first set of business data in a first format from a real business process from a first data source; and stores the first set of business data into memory. The method also inputs a second set of business data in the first format from a real business process from a second data source and stories the second set of business data into memory. The method inputs a statistical classifier that processes business data in the first format and stores the classifier into memory. The method also compares the data from the first data source with the data from the second data source and determines whether the comparison indicates that the behavior of the classifier when applied to business data from the business process is different for the two data sources. The method displays the result of the analysis.

Many benefits are achieved by way of the present invention over conventional techniques. For example, the present technique provides an easy to use process that relies upon conventional technology. In some embodiments, the method provides for improved classification results from a statistical classifier. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified flow diagram of a method for determining a behavior of a classifier according to an embodiment of the present invention.

FIG. 2 is a simplified flow diagram of a method for determining a behavior of a classifier according to an alternative embodiment of the present invention.

FIG. 3A illustrates more detailed block diagrams of a classifier process according to embodiments of the present invention.

FIG. 3B illustrates more detailed block diagrams of a process for determining behavior of the classifier according to embodiments of the present invention.

FIG. 4 illustrates evaluation results for different concept drift metrics according to an embodiment of the present invention.

FIG. 5 shows the relationship between concept drift and improvability according to embodiments of the present invention.

FIGS. 6 and 7 show types of concept drift according to embodiments of the present invention.

### DETAILED DESCRIPTION OF THE INVENTION

According to the present invention, techniques for supporting business decisions through data analysis by way of enriching data through data mining, text mining, and automatic classification are provided. More particularly, the invention provides a method and system for 1) automatic detection of change in the business processes to be analyzed; 2) accurate measurement of the performance of automatic classification of business process data; 3) automatic handling of semi-structured text in business process analysis; and 4) efficient and maintainable scripting of the data enrichment process. Business decisions generally require knowledge about properties of business entities related to the decision. Such properties can be inferred by an automatic classifier that processes data associated with the entity. Parts of the data may be human-generated or free form text. Other parts of the data may be machine-generated or semi-structured. It is beneficial to analyze both free form text and semi-structured text data for business process analysis. While the enrichment process can be programmed in a number of existing programming languages and data base query languages, it is advantageous to provide a specialized language for increased maintainability and faster development of the enrichment process. By way of example for the enabling features of such a language, we describe SQXML, a language developed by Enkata Technologies, Inc. for this purpose. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

A method for detecting change in a statistical classifier for business data can be outlined as follows:
1. Input a first set of business data in a first format from a real business process from a first data source;
2. Store the first set of business data into one or more memories;
3. Input a second set of business data in a second format from a real business process from a second data source;
4. Store the second set of business data into one or more memories;
5. Form a statistical classifier by inputting the first set of business data into a learning process associating with the statistical classifier that processes business data in the first format;
6. Store the classifier into the one or more memories, the classifier being associated with the first set of data in the first format;
7. Process the data from the first data source in the statistical classifier to derive a first result;
8. Process the data from the second data source in the statistical classifier to derive a second result;
9. Determine a behavior of the statistical classifier based upon at least the first result and the second result;
10. Display information associated with the behavior of the statistical classifier; and
11. Perform other steps, as desired.

The above sequence of steps provides a method according to an embodiment of the present invention. As shown, the method uses a combination of steps including a way of checking a statistical classifier to change whether it has changed? based upon changes associated with the business data being processed. Of course, other alternatives can also be provided where steps are added, one or more steps are removed, or one or more steps are provided in a different sequence without departing from the scope of the claims herein. Further details of the present method can be found throughout the present specification and more particularly below.

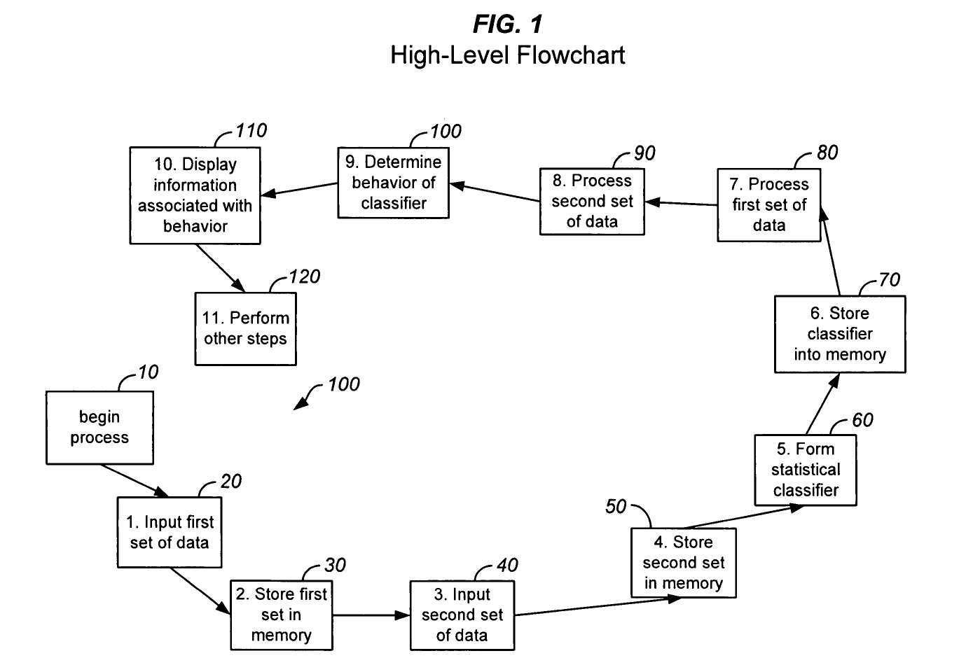

FIG. 1 is a simplified flow diagram of a method 100 for determining a behavior of a classifier according to an embodiment of the present invention. This diagram is merely an illustration, and should not unduly limit the scope of the claims herein. One of ordinary skill in the art would recognize many variations, alternatives, and modifications. Details of the flow diagram are outlined below.

1. Begin Process (Step 10)

The method begins by providing a system for determining the behavior of a classifier. A part of the system is the input module for reading business data and the classifier into the system. Another part of the system is the processing module that processes the business data after input and applies the classifier. Yet another part of the system is the decision module that takes the output of the processing module and computes a characterization of the behavior of the classifier. Still another part of the system is the display module which displays the characterization to a user. Of course, there can be other variations, modifications, and alternatives.

2. Input First Set of Data (Step 20)

Input the first set of data into the system. In the example, the first set of data consists of all Reuters newswire stories between Aug. 20 and Sep. 10, 1996 (the training interval).

3. Store First Set in Memory (Step 30)

The first set of data is stored in memory. In the example, the first set of data consisting of the training interval is stored in memory.

4. Input Second Set of Data (Step 40)

Input the second set of data into the system. In the example, the second set of data consists of all Reuters newswire stories between Sep. 10 and 28, 1996 (the first test interval).

5. Store Second Set in Memory (Step 50)

The second set of data is stored in memory. In the example, the first test interval of the Reuters collection is stored in memory.

6. Form Statistical Classifier (Step 60)

A learning algorithm is used to build a statistical classifier based on the first set of data and its labeling with respect to the class of interest. In the example, a Naive Bayes classifier is built for the Reuters category Bulgaria.

7. Store Classifier in Memory (Step 70)

The classifier is stored in memory. In the example, the Naive Bayes classifier is stored in memory.

8. Process First Set of Data (Step 80)

The first set of data is processed by the classifier. In the example, the Naive Bayes classifier is applied to each of the documents in the first interval of the Reuters data set. we get a score for each document, a score above the classifier's threshold indicating that the classifier assigns the document to the class, a score below the classifier's threshold indicating that the classifier does not assign the document to the class.

9. Process Second Set of Data (Step 90)

The second set of data is processed by the classifier. In the example, the Naive Bayes classifier is applied to each of the documents in the second interval of the Reuters data set (the first test interval). We get a score for each document, a score above the classifier's threshold indicating that the classifier assigns the document to the class, a score below the classifier's threshold indicating that the classifier does not assign the document to the class.

10. Determine Behavior of Classifier (Step 100)

We determine the behavior of the classifier based on the two classification results. In the example, we compute the absolute log difference of the predicted frequency of the class in the first interval and the predicted frequency of the class in the second interval (the first test interval). The predicted frequency in the second interval is 0.00538, the predicted frequency in the first interval is 0.00365, and the absolute log difference is 0.168.

11. Display Information Associated with the Behavior (Step 110)

The behavior and associated information is displayed to the user. In the example, the absolute log difference and associated information such as the distribution of scores and the counts of assigned and non-assigned documents is displayed. The display can also support the user by displaying a guess as to whether the displayed statistics indicate that the behavior of the classifier has changed or not. For example, we can choose a threshold such as 0.4. For an absolute log difference above 0.4 the system guesses that the behavior has changed, for a difference below 0.4 the system guesses that the behavior has not changed. Since 0.168 is smaller than 0.4 the system guesses that the behavior of the classifier has not changed. In this example, we use ratio of accuracy as the statistic that defines whether a change occurred or not. Accuracy is estimated using the F measure, the harmonic mean of precision and recall. We stipulate that if the ratio of accuracies is above 1.8 (that is, accuracy has declined by 80% or more), then a change in behavior has occurred, otherwise no change has occurred. In the example, the ratio of accuracies is 1. 18, so no change has occurred. This means that the system guessed correctly in this case.

12. Perform Other Steps (Step 120)

Other steps are performed. Active learning may be triggered if a change has been detected. No additional learning is triggered in this case since no change was detected.

The above sequence of steps provides a method according to an embodiment of the present invention. As shown, the method uses a combination of steps including a way of checking a statistical classifier for change based upon changes associated with the business data being processed. Of course, other alternatives can also be provided where steps are added, one or more steps are removed, or one or more steps are provided in a different sequence without departing from the scope of the claims herein.

A method for determining a behavior of a statistical classifier according to an embodiment of the present invention may be outlined as follows:
1. Input a first set of business data in a first format from a real business process from a first data source;
2. Store the first set of business data into one or more memories;
3. Form a statistical classifier by inputting the first set of business data into a learning process associated with the statistical classifier that processes the first set of business data in the learning process that creates a statistical classifier that processes the first set of business data in the first format;
4. Store the classifier into the one or more memories, whereupon the classifier is associated with the first set of data in the first format;
5. Process the data from the first data source in the statistical classifier to derive a first result;
6. Process the data from the nth data source in the statistical classifier to derive an nth result;
7. Determine a behavior of the statistical classifier based upon at least the first result and the nth result;
8. Output information associated with the behavior of the statistical classifier;
9. Repeat steps of inputting, storing, processing, and determining for other nth set of business data where n is greater than 2; and
10. Perform other steps, as desired.

The above sequence of steps provides a method according to an embodiment of the present invention. As shown, the method uses a combination of steps including a way of checking a statistical classifier for change based upon changes associated with the business data being processed. Of course, other alternatives can also be provided where steps are added, one or more steps are removed, or one or more steps are provided in a different sequence without departing from the scope of the claims herein. Certain details of the present method can be found throughout the present specification and more particularly below.

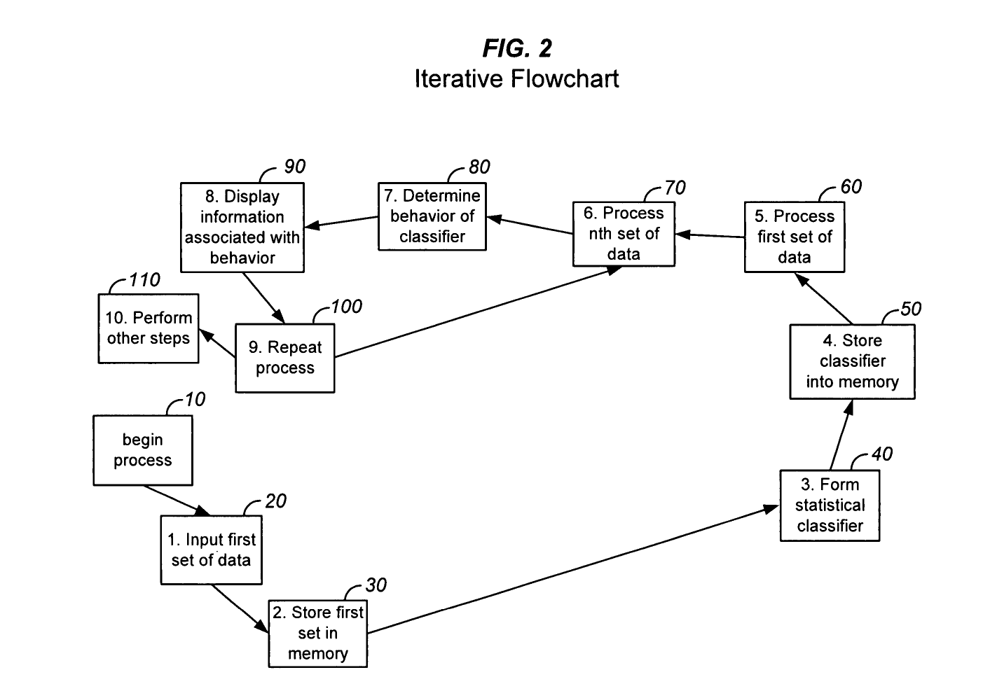

FIG. 2 is a simplified flow diagram of a method 200 for determining a behavior of a classifier according to an alternative embodiment of the present invention. This diagram is merely an illustration, and should not unduly limit the scope of the claims herein. One of ordinary skill in the art would recognize many variations, alternatives, and modifications. Details of the flow diagram are outlined below.

1. Begin Process (Step 10)

The method begins by providing a system for determining the behavior of a classifier. A part of the system is the input module for reading business data and the classifier into the system. Another part of the system is the processing module that processes the business data after input and applies the classifier. Yet another part of the system is the decision module that takes the output of the processing module and computes a characterization of the behavior of the classifier. Still another part of the system is the display module which displays the characterization to a user. Of course, there can be other variations, modifications, and alternatives.

2. Input First Set of Data (Step 20)

Input the first set of data into the system. In the example, the first set of data consists of all Reuters newswire stories between Aug. 20 and Sep. 10, 1996 (the training interval).

3. Store First Set in Memory (Step 30)

The first set of data is stored in memory. In the example, the first set of data consisting of the first interval of the Reuters collection is stored in memory.

4. Form Statistical Classifier (Step 40)

A learning algorithm is used to build a statistical classifier based on the first set of data and its labeling with respect to the class of interest. In the example, a Naive Bayes classifier is built for the Reuters category Bulgaria.

5. store Classifier in Memory (Step 50)

The classifier is stored in memory. In the example, the Naive Bayes classifier is stored in memory.

6. Process First Set of Data (Step 60)

The first set of data is processed by the classifier. In the example, the Naive Bayes classifier is applied to each of the documents in the first interval of the Reuters data set. We get a score for each document, a score above the classifier's threshold indicating that the classifier assigns the document to the class, a score below the classifier's threshold indicating that the classifier does not assign the document to the class.

7. Process nth Set of Data (Step 70)

The nth set of data is processed by the classifier. In the example, the Naive Bayes classifier is applied to each of the documents in the nth interval of the Reuters data set. we get a score for each document, a score above the classifier's threshold indicating that the classifier assigns the document to the class, a score below the classifier's threshold indicating that the classifier does not assign the document to the class. The 10 intervals in the example consist of all the documents in the time periods Sep. 10-Sep. 28, 1996 (test interval 1), Sep. 28-Oct. 17, 1996 (test interval 2), Oct. 17-Nov. 4, 1996 (test interval 3), Nov. 4-Nov. 20, 1996 (test interval 4), Nov. 20-Dec. 9, 1996 (test interval 5), Dec. 9, 1996-Jan. 2, 1997 (test interval 6), Jan. 2-Jan. 22, 1997 (test interval 7), Jan. 22-Feb. 7, 1997 (test interval 8), Feb. 7-Feb. 26, 1997 (test interval 9), and Feb. 26-Mar. 14, 1997 (test interval 10).

8. Determine Behavior of Classifier (Step 80)

We determine the behavior of the classifier based on the two classification results. In the example, we compute the absolute log difference of the predicted frequency of the class in the first interval and the predicted frequency of the class in the nth interval. The 10 differences we obtain are: 0.168 (interval 1), 0.246 (interval 2), 0.350 (interval 3), 0.355 (interval 4), 0.279 (interval 5), 0.341 (interval 6), 0.272 (interval 7), 0.408 (interval 8), 0.393 (interval 9), 0.337 (interval 10).

9. Display Information Associated with the Behavior (Step 90)

The behavior and associated information is displayed to the user. In the example, the absolute log difference and associated information such as the distribution of scores and the counts of assigned and non-assigned documents is displayed for all 10 intervals. The display can also support the user by displaying a guess as to whether the displayed statistics indicate that the behavior of the classifier has changed or not. For example, we can choose a threshold such as 0.4. For an absolute log difference above 0.4 the system guesses that the behavior has changed, for a difference below 0.4 the system guesses that the behavior has not changed. Only the absolute log difference for interval 8 is larger than 0.4. All other absolute log differences are smaller than 0.4. So the system guesses that the behavior of the classifier has changed for interval 8, and that it has not changed for the other intervals.

In this example, we use ratio of accuracy as the statistic that defines whether a change occurred or not. Accuracy is estimated using the F measure, the harmonic mean of precision and recall. We stipulate that if the ratio of accuracies is above 1.8 (that is, accuracy has declined by 80% or more), then a change in behavior has occurred, otherwise no change has occurred. In the example, the ratios of accuracies are 1.18 (1), 1.36 (2), 1.63 (3), 1.47 (4), 1.37 (5), 1.61 (6), 1.78 (7), 2.1 (8), 1.66 (9), and 1.49 (10). So the behavior of the classifier changed for interval 8. It did not change according to the definition for the other 9 intervals. This means that the system guessed correctly in this case for all 10 intervals.

10. Repeat Process: Steps 6-8 are Repeated for Each Interval (Step 100)

11. Perform Other Steps (Step 110)

Other steps are performed. In the example, active learning is triggered for the class on the eighth interval since a change has occurred.

The above sequence of steps provides a method according to an embodiment of the present invention. As shown, the method uses a combination of steps including a way of checking a statistical classifier for change based upon changes associated with the business data being processed. Of course, other alternatives can also be provided where steps are added, one or more steps are removed, or one or more steps are provided in a different sequence without departing from the scope of the claims herein.

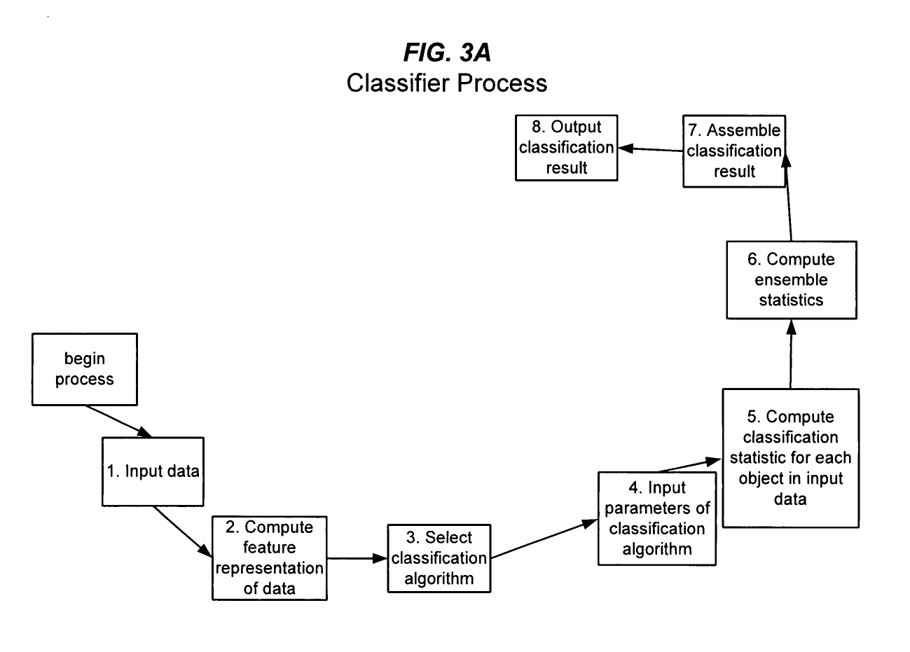

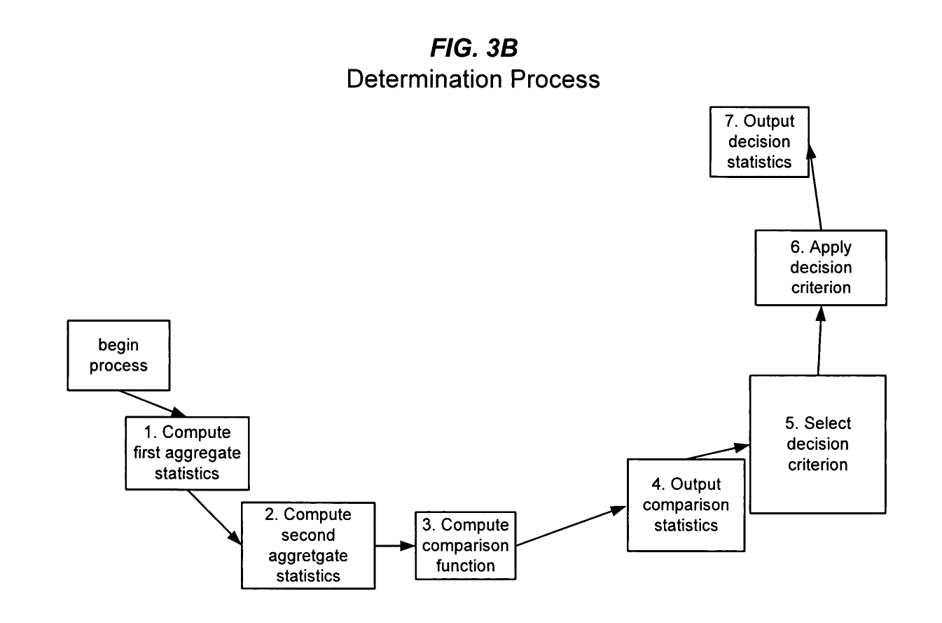

FIG. 3A illustrates more detailed block diagram of a classifier process and a process for determining behavior of the classifier according to embodiments of the present invention. This diagram is merely an example, which should not unduly limit the scope of the claims herein. One of ordinary skill in the art would recognize many variations, modifications, and alternatives. As shown, the classifier process includes certain steps, which have been provided as follows:

1. The classifier process reads the input data.

2. The classifier process computes a feature representation of the input data.

3. The classifier process selects a classification algorithm.

4. The classifier process reads the classification parameters.

5. The classifier process uses the classification algorithm with the parameters to compute a classification statistic for each object.

6. The classifier process computes ensemble statistics for the input data as a whole.

7. The classifier process assembles the classification statistics and the ensemble statistics into the classification result.

8. The classifier process outputs the classification result.

The above sequence of steps provides a method according to an embodiment of the present invention. As shown, the method uses a combination of steps including a way of classifying associated with the business data being processed. Of course, other alternatives can also be provided where steps are added, one or more steps are removed, or one or more steps are provided in a different sequence without departing from the scope of the claims herein.

FIG. 3B illustrates more detailed block diagram of a process for determining behavior of the classifier according to embodiments of the present invention. This diagram is merely an example, which should not unduly limit the scope of the claims herein. One of ordinary skill in the art would recognize many variations, modifications, and alternatives. As shown, the determination process has various steps, which will be described as follows:

We compute aggregate statistics for the first set of data from the first classification result (1).

Then, we compute aggregate statistics for the second set of data from the first classification result (2).

Then, we compute a comparison function based on the first aggregate statistics and the second aggregate statistics (3). In a specific embodiment, the comparison function can be a simple difference of one quantity that is part of the first aggregate statistics and the corresponding quantity that is part of the second aggregate statistics. In an alternative embodiment, the comparison function can also be a more complex function of the first aggregate statistics and the second aggregate statistics. Of course, other types of functions can also be used.

The comparison function outputs comparison statistics (4).

Then we select a decision criterion from a list of possible decision criteria for characterizing the behavior of the classifier (5).

Finally, we apply the decision criterion to the comparison statistics (6). The decision criterion can be a threshold applied to a particular quantity that is part of the comparison statistics. Or it can be a more complex function of the comparison statistics according to an alternative embodiment.

The decision criterion outputs decision statistics (7). Depending upon the embodiment, the decision statistics can be a binary variable, indicating whether or not change occurred; they can be a probability indicating the probability that change occurred; or they can be a more complex set of information that describes the behavior of the classifier in a form that can be used in a human decision. Of course, other types of outputs can be provided depending upon the embodiment.

The above sequence of steps provides a method according to an embodiment of the present invention. As shown, the method uses a combination of steps including a way of classifying associated with the business data being processed. Of course, other alternatives can also be provided where steps are added, one or more steps are removed, or one or more steps are provided in a different sequence without departing from the scope of the claims herein.

1. Automatic Detection of Change in Business Process Data

In automatic classification, a classifier is trained to predict an unknown property of interest from known data. If the distribution of the known data changes over time, then the classifier may make incorrect predictions. It is thus important to be able to detect such changes. One way of doing this is to have a person monitor the distribution of data or the output of the classifier. However, this is expensive. What is claimed here is an automatic way of detecting change. A type of change that is of particular interest is change that causes degradation of classification performance measured by a quantity such as accuracy, precision, recall or a combination. We call this degradation concept drift. Detecting concept drift is important in deployments of classification. Statistical classification requires a training set for parameter estimation. This training set also can be used to estimate performance on the training data. But there are no known methods for estimating performance for data sets without training data. Solving this problem is critical for determining whether a classification implementation will produce satisfactory results for a client. A complex enterprise is constantly changing. At some point, any classifier will encounter new data that it cannot handle correctly. Determining the time in point when this happens is the purpose of concept drift diagnosis.

1.1 Improvability

In addition to the core notion of concept drift, we also define a variation of concept drift, which we call improvability. Improvability measures how much a classifier can be improved by retraining. Improvability is also of practical interest in using classification for business process analysis because we are mostly interested in detecting problems that we can fix. If a classifier's performance degrades, but no amount of retraining can bring performance up to previous levels, then knowledge of the problem is less useful. Improvability measures to what extent the detected problem can be fixed.

1.2 High-Level Description of Metrics

There are four metrics and their combination for the detection of concept drift that we have found useful.
PD: Proportion decrease. By how much does the predicted relative frequency of a class decrease?
PC: Absolute proportion change. By how much does the predicted relative frequency of a class change? We measure this by the absolute of the log of the ratio of old and new performance.
SP: Small proportion. Low relative frequency by itself is sometimes a good predictor of bad classification performance.
WC: Word distribution change. By how much have the words (or, in general, the classification features) changed that occur in documents (or, in general, objects to be classified) that are predicted to be in the class?

In our experiments, we found that proportion decrease is the best predictor of concept drift. However, it is beneficial to make a variety of metrics available to the user for identifying classes in need of retraining. Depending on the circumstances, the following metrics may be as effective as predictors as the ones we found optimal in the context of contact center data.

Similarity/distance measure on contingency table rows. This metric can be applied if there is a multitude of classes. The contingency table cell of classes i and j contains the number of documents that are predicted to be in both i and j. Compute a contingency table for training and test intervals. For a specific class, compute a distance measure (e.g., the KL divergence) between rows of training and test intervals as a metric of how much that class has drifted.

Conditional probability of good indicators in bad documents. Use a criterion such as chi-square to identify features (e.g., words) that are good indicators of a class. Then compute the conditional probability that a good indicator occurs in a document with a negative classification. A high conditional probability may indicate concept drift.

Similarity/distance measure on score distribution. This can be applied if the classifier is one that in the end comes up with a real number for each object to be classified. (In some cases that real number can be an integer or rational number.) Call this real number the object's score. Compute the distribution of scores on training and test intervals and apply some distance measure (e.g., KL divergence). The distance is a predictor of how much concept drift has occurred. Variant: Focus the measure on part of the distribution, e.g., the highest 10%, or all scores that are higher than a specific number.

Probabilistic predictions. It should be obvious to a person versed in the art that all metrics can be implemented using probabilistic predictions instead of the discrete predictions used here. For example, discrete predictions compute the predicted number of objects in an interval as the count of all positive (discrete) predictions. Probabilistic predictions compute the predicted number of objects in an interval as the sum of the probabilities of the predictions for the individual objects.

Combination of metrics. It should be obvious to a person versed in the art that all metrics can be combined into composite metrics. One way of combining pairs of metrics is described below, but any function of any number of metrics in turn can be used as a composite metric.

1.3 Definitions

Let F0 and F1 be the performance figures of the classifier of interest as measured by the F measure on training set and test set, respectively. The F measure is the harmonic mean of precision and recall. A multitude of other measures can be substituted for F without affecting the mechanics of the concept drift detection and improvability detection algorithms described here. We define performance degradation d as:

$$d = \frac{{F}_{1}}{{F}_{0}}$$

We define concept drift (cd) as cases with d<0.9. We define statistically significant concept drift (cd-s) as cases where the null hypothesis d>=0.9 can be rejected with 95% confidence. Depending on the application, values different from 0.9 and 95% can be chosen. We reject the null hypothesis if the following holds: (1.645 corresponds to a one-sided 95% confidence interval)
0.9*m₀−m₁>1.645\sqrt{s₀²/n₀+s₁²/n₁}
where m₀ and m₁ are the sample means, s₀ and s₁ are the sample standard deviations for F₀ and F₁, and n₀ and n₁ are the sample sizes. m and s can be estimated by a number of parametric and non-parametric methods, e.g., bootstrapping or the jackknife. The results shown below are computed by bootstrapping. For F₀, we draw an 80% sample with replacement, we split it into two halves, train on the first half, apply to the other half, reverse, and sum up the two contingency tables. This gives us one estimate of F₀. We do n=10 trials, and compute mean and variance from these 10 trials. For F₁, we first build a classifier trained on the entire training set. We then draw a 50% sample with replacement from the test set and compute performance. This gives us one estimate of F₁. Again, mean and variance are based on n₁=10 trials. The variance of the difference between F₀ and F₁ is then computed as the sum of the individual variances.
Let R₁ be the performance of a classifier on the test set after retraining. It is measured the same way as F₀ by bootstrapping. We define performance improvability i as:

$$i = \frac{{F}_{1}}{{R}_{1}}$$

We define simple performance recovery (pr) as cases with i<0.9. We define statistically significant performance recovery (pr-s) as cases where the null hypothesis i>=0.9 can be rejected with 95% confidence. Choices different from 0.9 and 95% are possible depending on the circumstances. We can reject the null hypothesis if the following holds:
0.95*mf₁−m₁>1.6451\sqrt{sf₁²/n₀+s₁²/n₁}

where mf1 is the sample mean of n0 classifiers and sf1 is the sample deviation of a set of n1 classifiers trained and evaluated on bootstrap samples of the test set computed as before.

1.4 Metrics

1.4.1 Proportion Decrease

Let \hat{ }p0 and \hat{ }p1 be the estimated probability of objects in the class in training set and test set, respectively. We estimate \hat{ }p using the maximum likelihood estimator C/N where C is the number of positive predictions and N is the total number of documents. The predicted proportion decrease is defined as:

$${pd}_{01} = {log}_{10} \frac{{\hat{p}}_{1}}{{\hat{p}}_{0}}$$

We do not define this measure for \hat{ }p0=0 since we assume that we had a sufficient number of training examples in the training set and were able to train a classifier with reasonable performance.

1.4.2 Proportion Change

Let \hat{ }p0 and \hat{ }p1 be as before. Then (absolute) proportion change is defined as:

$${pc}_{01} = \vert {log}_{10} \frac{{\hat{p}}_{1}}{{\hat{p}}_{0}} \vert$$

Let \hat{ }p1 be as before. Then the small proportion metric is defined as:
sp₀₁=\hat{ }p₁

1.4.4 Word Distribution Change

The word distribution change metric is based on estimating a multinomial word distribution for the documents predicted to be in the class. This is done by counting the number of times that a word occurs in documents predicted to be in the class. We then identify the W words with the highest counts. (In our experiments, W=20, 000 other choices are possible, depending on the application.) The multinomial is defined as: (the “sum” sigma below shows up as a Swedish a in my version of doc. Please correct and use Σ)

$$P ( {w}_{i} ) = \frac{{f}_{i}}{{\sum }_{i} {f}_{i}}$$

We compute multinomials P0 and P1 for training and test set, respectively. Finally, we compute the following variant of the KL divergence to compute the word distribution change metric: Below, replace the P with ∥, so that it reads (P0μfraction) and (P1μfraction)

$${wc}_{01} = D ( {P}_{0} ‖ \frac{{P}_{0} + {P}_{1}}{2} ) + D ( {P}_{1} ‖ \frac{{P}_{0} + {P}_{1}}{2} )$$

It should be obvious to one versed in the art that other distributions characterizing the occurrence of words in documents and other similarity or distance measures can be used.

1.4.5 Combinations

We also look at all four pair wise combinations. We combine by ranking each metric. The value of an interval-class pair for the combination metric is then the sum of the two ranks from the individual metrics. We make sure that ranks are oriented in the right direction in the case of metrics that identify concept drift by small vs. large values.

1.5 Evaluation Methodology

We use the Reuters RCV1 corpus. We split its 800,000 documents into 20 equal sized intervals. We then eliminate duplicates. Our training set is interval 0. We compute F0 for all classes that have at least 40 documents in interval 0. Our test sets are intervals 1, 5, 10, 15 and 19. We selected the 100 classes that have the highest value for m −1.64s where m and s are the estimates for mean and standard deviation of F as described above. This selects classes with relatively high performance and relatively low variance.

1.6 Evaluation Results

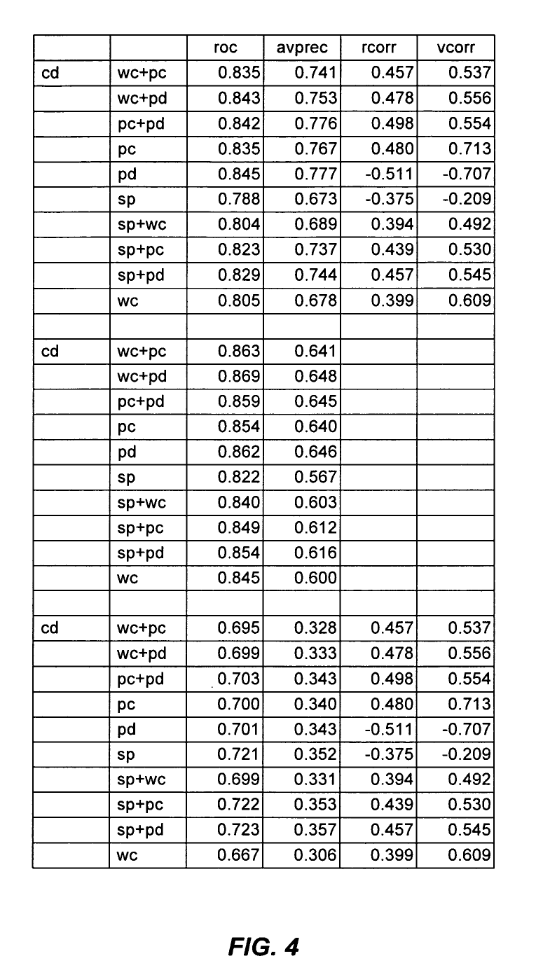

Evaluation results are shown in FIG. 4. We use four evaluation measures. ROC is the area under the roc curve. This is the area under the receiver operating characteristic curve which plots the true positive rate on the y axis and the false positive rate on the x axis. AvPrec is precision averaged over all interval-class pairs that exhibit concept drift. For example, if there are three such pairs, and after having ranked all pairs according to the metric under investigation, these three pairs receive ranks 1, 3 and 4, then average precision is: (below replace the square with the approx symbol: ≈)
(1/1+2/3+3/4)/3≈0.8056≈8

Value correlation and rank correlation measure the correlation between d and i on the one hand and the metrics on the other. Note that we do not need to define a threshold in this case. The two correlation measures thus evaluate the metrics independent of any hard threshold. The best performing metric for detecting concept drift is proportion decrease. This is clear for the simple concept drift definition cd. The results from the significant version cd-s provide further evidence for this conclusion. Ironically, since there are many fewer cases of significant concept drift than simple concept drift, the estimates for cd-s are less differentiated since they are based on fewer interval-class pairs. But the roc value of 0.862 for pd is the best non-combination metric, and very close to the best overall metric (0.869), a combination of pd and wc. Note that statistically significant concept drift can be detected more reliably than simple concept drift as one would expect. The results for improvability are less consistent. Here, proportion decrease, small proportion and their combination are the best metrics except for one case (proportion change has a slight edge for the value correlation metric). This again argues for proportion decrease as the primary metric, supplemented by small proportion. However, all metrics contribute important information, so ideally, information on all of them should be made available to the user.

1.7 Concept Drift and Improvability

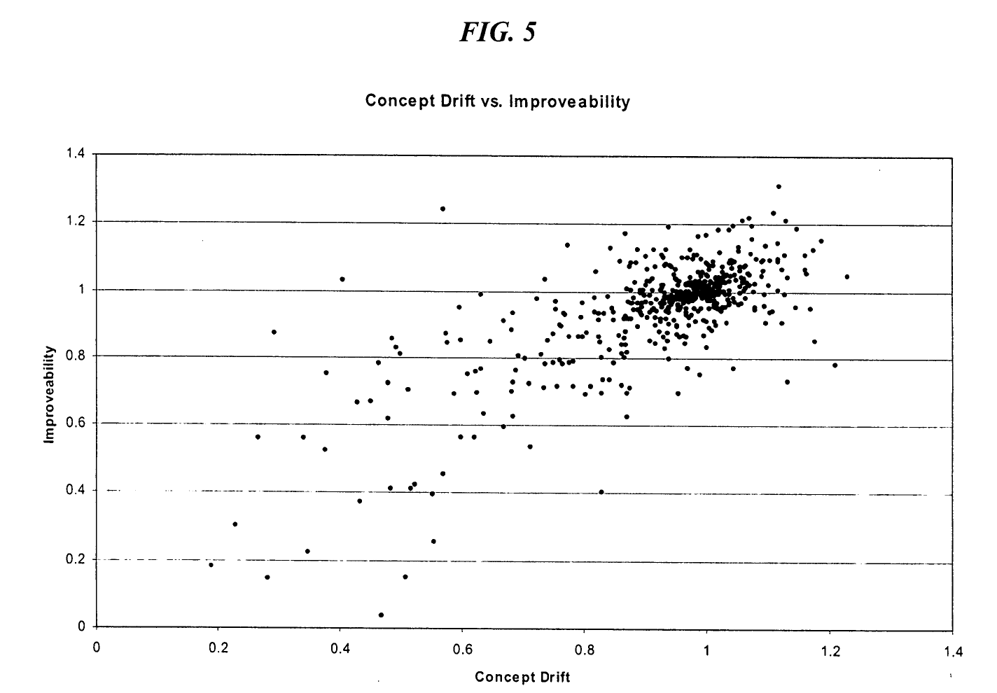

FIG. 5 shows the relationship between concept drift and improvability. The relationship is roughly linear, but noisy. Not surprisingly, severe performance degradation is correlated with great performance improvability. However, predicting the exact magnitude of improvability from drift is difficult.

1.8 Types of Concept Drift

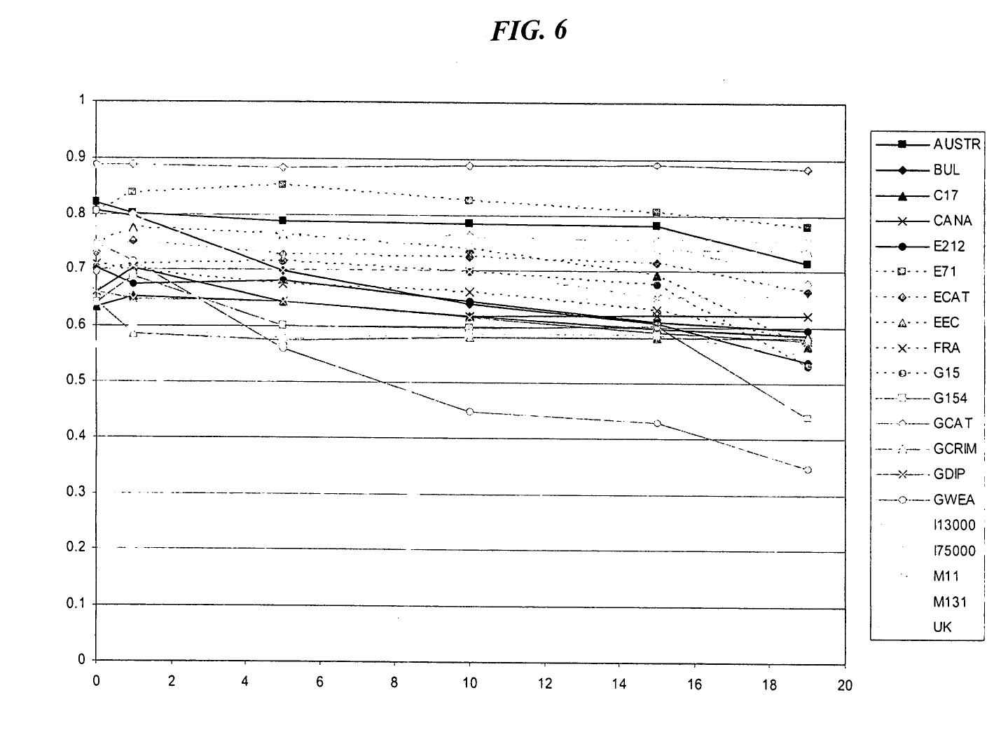

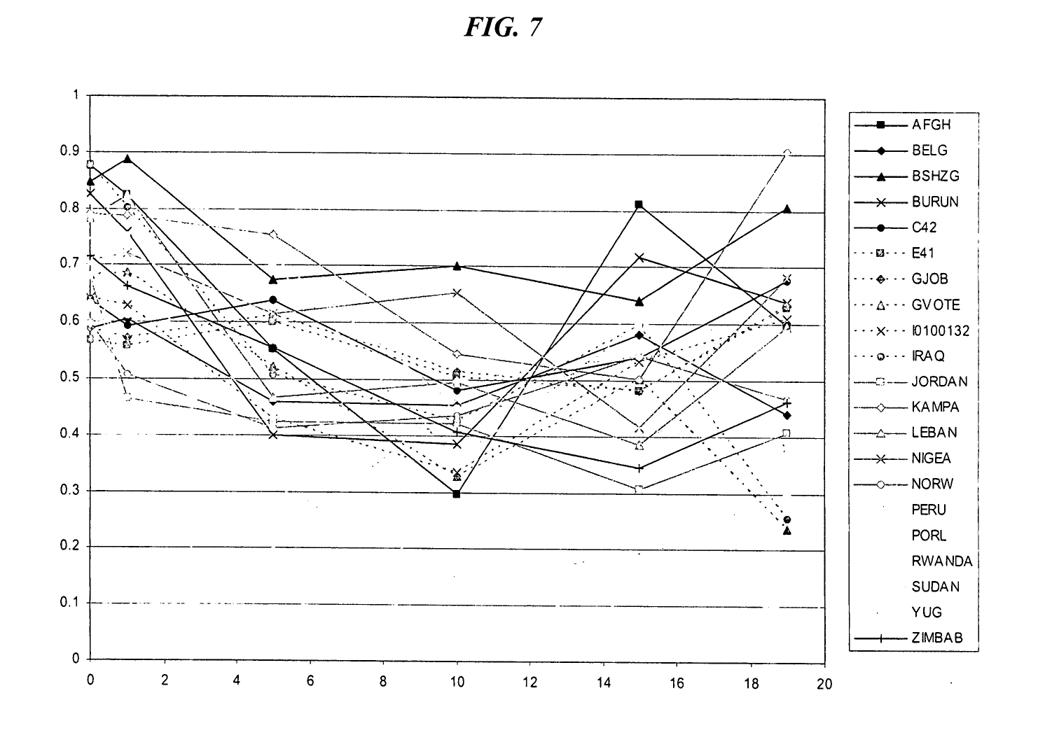

FIGS. 6 and 7 show types of concept drift. One might expect performance to go down consistently over time. That is not the case, at least for Reuters. There are some classes for which performance does decrease more or less consistently (FIG. 6). Most classes exhibit periods of increased performance as well as periods of decreased performance (FIG. 7).

1.9 Limitations

The experiments on Reuters were conducted on a set without duplicates. Concept drift is expected to be higher if there are duplicates in the training set. This is so because duplicates artificially increase classification accuracy on the training set (even on an “objective” measure like cross-validation).

It is also understood that the examples and embodiments described herein are for illustrative purposes only and that various modifications or changes in light thereof will be suggested to persons skilled in the art and are to be included within the spirit and purview of this application and scope of the appended claims.

1. A method for detecting change in business data, the method comprising:
inputting a first set of business data in a first format from a real business process from a first data source;
storing the first set of business data into one or more memories;
inputting a second set of business data in a second format from a real business process from a second data source;
storing the second set of business data into one or more memories;
forming a statistical classifier by inputting the first set of business data into a learning process associating with the statistical classifier that processes business the data in the first format;
storing the classifier into the one or more memories, the classifier being associated with the first set of data in the first format;
processing the data from the first data source in the statistical classifier to derive a first result;
processing the data from the second data source in the statistical classifier to derive a second result;
determining a behavior of the statistical classifier based upon at least the first result and the second result; and
displaying information associated with the behavior of the statistical classifier.

2. The method of claim 1 wherein the first data source and the second data source refer to a source at different points in time.

3. The method of claim 1 wherein the first result is a pattern or a number result and the second result is a pattern or a number result.

4. The method of claim 1 wherein the determining comprises comparing the first result with the second result.

5. The method of claim 1 wherein the first format and the second format are the same format.

6. The method of claim 1 wherein the behavior changes if the first result and the second result are substantially different.

7. The method of claim 1 wherein the behavior changes if the first result and the second result do not change.

8. The method of claim 1 wherein the displaying comprises outputting the information on a display.

9. The method of claim 1 further comprising outputting the second result.

10. A method for detecting change in business data, the method comprising:
inputting a first set of business data in a first format from a real business process from a first data source;
storing the first set of business data into one or more memories;
forming a statistical classifier by inputting the first set of business data in the first format into a learning process associated with the statistical classifier to process the first set of business data in the learning process;
storing the classifier into the one or more memories, the classifier being associated with the first set of data in the first format;
processing the data from the first data source in the statistical classifier to derive a first result;
processing the data from the nth data source in the statistical classifier to derive an nth result;
determining a behavior of the statistical classifier based upon at least the first result and the nth result;
outputting information associated with the behavior of the statistical classifier; and
repeating steps of inputting, storing, processing, and determining for other nth set of business data where n is greater than 1.

11. A system performing the method of claim 10.

12. A method for detecting change in business data, the method comprising:
inputting a first set of business data in a first format from a real business process from a first data source;
storing the first set of business data into memory;
inputting a second set of business data in the first format from a real business process from a second data source;
storing the second set of business data into memory;
inputting a statistical classifier that processes business data in the first format;
storing the classifier into memory;
comparing the data from the first data source with the data from the second data source;
determining whether the comparison indicates that the behavior of the classifier when applied to business data from the business process is different for the two data sources;
displaying the result of the analysis.

13. The method in 12 wherein the data sources correspond to time periods.

14. The method in 13 wherein the first data source corresponds to an earlier time period and the second data source corresponds to a later time period.

15. The method in 12 wherein the behavior of the classifier is some form of classification accuracy.

16. The method in 15 wherein accuracy is measured by precision, recall or a combination thereof.

17. The method in 12 wherein the behavior of the classifier is optimal classification performance.

18. The method in 17 wherein optimal classification performance is measured by precision, recall or a combination thereof.

19. The method in 12 wherein a gold set of human-labeled business data is created and the gold set is used as part of the determination as to whether the behavior of the classifier is different.

20. The method in 12 wherein a metric is computed as part of the comparison and the metric is used as part of the determination as to whether the behavior of the classifier is different.

21. The method in 20 wherein a threshold is computed and different behavior is predicted to occur if the metric is higher than the threshold.

22. The method in 20 wherein several classifiers are investigated for behavior differences and the metric is used to rank the classifiers as to likelihood of different behavior.

23. The method in 22 wherein the ranked list of classifiers is displayed to a user for further decision making.

24. The method in 20 wherein the metric is proportion decrease.

25. The method in 24 wherein proportion decrease is computed based on probabilistic predictions or discrete predictions.

26. The method in 20 wherein the metric is proportion change.

27. The method in 20 wherein proportion change is computed based on probabilistic predictions or discrete predictions.

28. The method in 20 wherein the metric is small proportion.

29. The method in 20 wherein small proportion is computed based on probabilistic predictions or discrete predictions.

30. The method in 20 wherein the metric is distribution change.

31. The method in 30 wherein distribution change is computed based on probabilistic predictions or discrete predictions.

32. The method in 20 wherein the metric is similarity or dissimilarity of contingency table rows.

33. The method in 32 wherein similarity or dissimilarity of contingency table rows is computed based on probabilistic predictions or discrete predictions.

34. The method in 20 wherein the metric is distribution of good indicators in bad documents or a subset of bad documents.

35. The method in 34 wherein distribution of good indicators in bad documents or a subset of bad documents is computed based on probabilistic predictions or discrete predictions.

36. The method in 20 wherein the metric is similarity or dissimilarity of score distributions.

37. The method in 36 wherein similarity or dissimilarity of score distributions is computed based on probabilistic predictions or discrete predictions.

38. The method in 20 wherein the metric is a combination of two or more of proportion decrease, proportion change, small proportion, distribution change, similarity or dissimilarity of contingency table rows, distribution of good indicators in bad documents or a subset of bad documents, or similarity or dissimilarity of score distributions.

39. The method in 12 wherein the two sets of business data are processed using a transformation such as duplicate elimination or near-duplicate elimination.

40. The method in 12 wherein the data comprise text.
